(19) United States
(12) Patent Application Publication
(10) Pub. No.: US 2005/0140980 A1
(43) Pub. Date: Jun. 30, 2005

(54) Optical measurement apparatus

(76) Inventors: Hei-Tong Ching, Taipei City (TW); Chin-Chang Chen, Hsin-Chu City (TW); Chien-Chi Chao, Taipei City (TW)

Correspondence Address: BIRCH STEWART KOLASCH & BIRCH, PO BOX 747, FALLS CHURCH, VA, 22040-0747, US

(21) Appl. No.: 10/827,491

(22) Filed: Apr. 20, 2004

(30) Foreign Application Priority Data
Dec. 25, 2003 (TW) 092136929

(51) Int. Cl. G01N 21/00

(52) U.S. Cl. 356/436

(57) ABSTRACT

An optical measurement apparatus is provided with a light source and guiding module and a receiving module in the present invention. The light source and guiding module, composed of a light source module and a light-guiding apparatus, is used to provide a low-cost area light source and to transfer the area light source to become a linear incident light through the light-guiding apparatus. And the receiving module, composed of a linear or area CCD sensor, is used to provide the linear or area detection for an array-type sample with the help of the light source and guiding apparatus. The present invention will simplify the complexity of the optical mechanism of two-dimension moving and single-point-scanning mode of the conventional optical measurement apparatus.

### BACKGROUND OF THE INVENTION

1. Field of the Invention

The present invention relates to an optical measurement apparatus, especially to be used to detect the optical characteristics of array-type samples by this optical measurement apparatus.

2. Description of the Prior Art

An optical measurement apparatus is popularly used in the bio-medical research fields, such as for decoding the sequence of genes, analyzing a protein structure, and developing genetic medication. For example, in the biochemical tests for a biochip, each grid of the microarray structure is capable of putting tens of thousands of chains of deoxyribonucleic acid (DNA) in it. And the optical measurement apparatus will be used to recognize the fluorescent marks generated from the matching reactions between the tested sample and the DNA. Different colors of the fluorescent marks will be compared and transformed as meaningful data by means of a computer.

As shown in FIG. 1, a conventional optical measurement apparatus 10 comprises a control system 12, a laser system 14, an excitation mirror 16, an optical system 18, a base 26, a two-dimensional positioning system 28, an emission mirror 30, a light filter 32, a focusing lens 34, an aperture stop 36, and a sensor 38. When the system is operating, the laser system 14 emits continuously excitation light 20. After the excitation light 20 passes through the optical system 18 to be projected onto a microarray 24 on the base 26, the two-dimensional positioning system 28 will be moved to read the photic signal of each grid on the microarray 24. Each photic signal on the microarray 24 will be transmitted by the emission light 22 produced after the excitation light 20 illuminates the fluorophore on each grid of the microarray 24. After passing through the optical system 18, the emission mirror 30, and the light filter 32, the emission light 22 will be focused by the focusing lens 34 to pass the aperture stop 36. Further, the emission light 22 will be projected onto the sensor 38 and the sensor 38 will read the photic signal of each grid on the microarray 24. Generally, the sensor is often a photomultiplier.

The aforementioned optical measurement apparatus 10 has a problem. The cost of the optical measurement apparatus 10 is so high that it prevents the optical measurement apparatus 10 from being prevalent in each research center or each hospital because the light source of the excitation light 20 is an expensive laser system 14. Further, the optical mechanism applied to a laser system 14 is too complicated to maintain and the frequency used by the optical measurement apparatus 10 is limited. Accordingly, there is a need for a light source of low cost.

In the other hand, because the way of scanning in the conventional optical measurement apparatus 10 is the way of continuous single-point-scanning, the time spent on scanning is too long and the continuous laser excitation light 20 causes a problem so that it is difficult for the sensor 38 to distinguish the desired signals from noise when the sensor 38 reads a signal. As a result, there is a need to have an efficient light guiding and signal receiving mechanism to swiftly and correctly read the fluorescent signals from the microarray 24.

Because the way in scanning of the conventional optical measurement apparatus 10 is a way of continuous single-point-scanning, the microarray 24 has to be implemented on the base 26, which moves two-dimensionally. In addition to the complicated optical mechanism, the space taken by the conventional optical measurement apparatus 10 is very big. The power consumption of the laser system 14 is also so high that the laser system wastes electric power. As a result, there is a need for an optical measurement apparatus that takes smaller space and consumes a lower amount of electric power.

### SUMMARY OF THE INVENTION

One purpose of the present invention is to provide an optical measurement apparatus for detecting the array-type samples. A light source and guiding module composed of a light source module and a light-guiding apparatus optical measurement apparatus used for forming a linear light, which is excited from an area light source module and passes through a wedged-shaped light-guiding apparatus. The area light source module comprises a light array formed by a plurality of light-emitting diodes (LEDs) or a plurality of organic light-emitting diodes (OLEDs), taking the place of the conventional laser system for the expensive cost and inconvenient maintaining. The optical measurement apparatus further comprises a platform for supporting and transporting the test sample and moving only in one-dimensional direction, simplifying the complexity of the optical mechanism of two-dimensional movement and single-point-scanning mode of the conventional optical measurement apparatus.

Another purpose of the present invention is provided with a linear or area charge coupled device (CCD) in a receiving module, taking the place of the photomultiplier in the prior art to reduce inaccuracy and processing time in receiving the image signal.

The present invention uses a light source and guiding module and a CCD to replace the laser system and the photomultiplier of the prior art. Compared with the conventional optical measurement apparatus, the optical measurement apparatus of the present invention has some advantages such as smaller space taken, lower cost, reduction of power consumption, and flexibility of design, intermittent excitation light, and variable frequencies of excitation light. Accordingly, the design and production cost of the whole optical measurement apparatus is lowered substantially and further the correct and swift scanning for an array-type sample is realized.

### BRIEF DESCRIPTION OF THE DRAWINGS

The foregoing aspects and many of the attendant advantages of this present invention will become more readily appreciated as the same becomes better understood by reference to the following detailed description, when taken in conjunction with the accompanying drawings, wherein:

FIG. 1 shows an illustrative chart of a conventional optical measurement apparatus;

FIG. 2A shows a perspective drawing of a straight-line-type wedge-shaped light-guiding apparatus according to the present invention;

FIG. 2B is a top view of a straight-line-type wedge-shaped light-guiding apparatus according to the present invention;

FIG. 2C shows a perspective drawing of an arc-line-type wedge-shaped light-guiding apparatus according to the present invention;

FIG. 2D is a top view of an arc-line-type wedge-shaped light-guiding apparatus according to the present invention;

FIG. 3 shows an optical measurement apparatus according to the present invention; and

FIG. 4 shows another optical measurement apparatus according to the present invention.

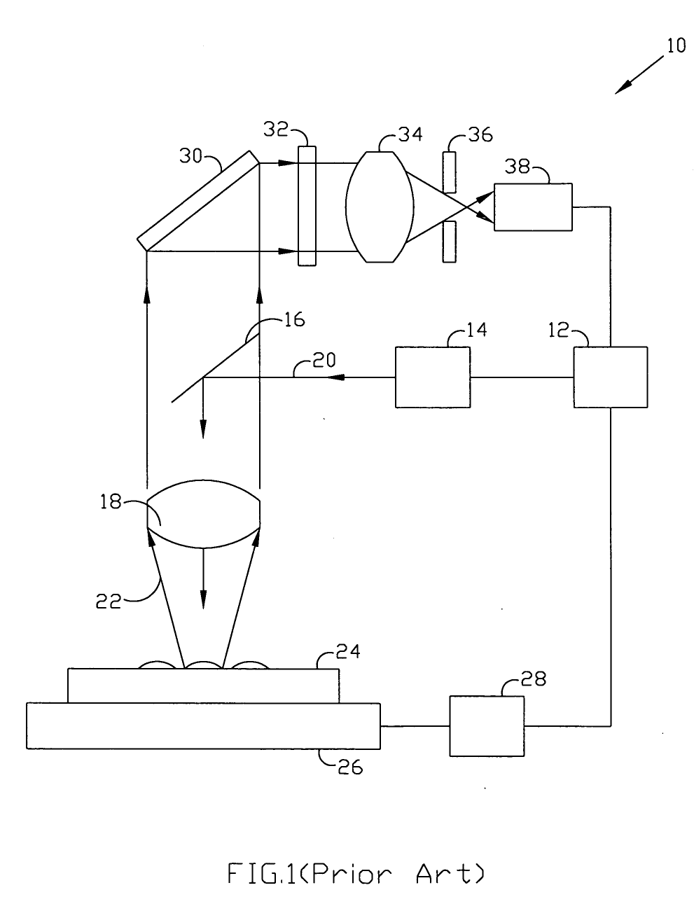

### DESCRIPTION OF THE PREFERRED EMBODIMENT

Some embodiments of the invention will be described exquisitely as below. Besides, the invention can also be practiced extensively in other embodiments. That is to say, the scope of the invention should not be restricted by the proposed embodiments. The scope of the invention should be based on the claims proposed later.

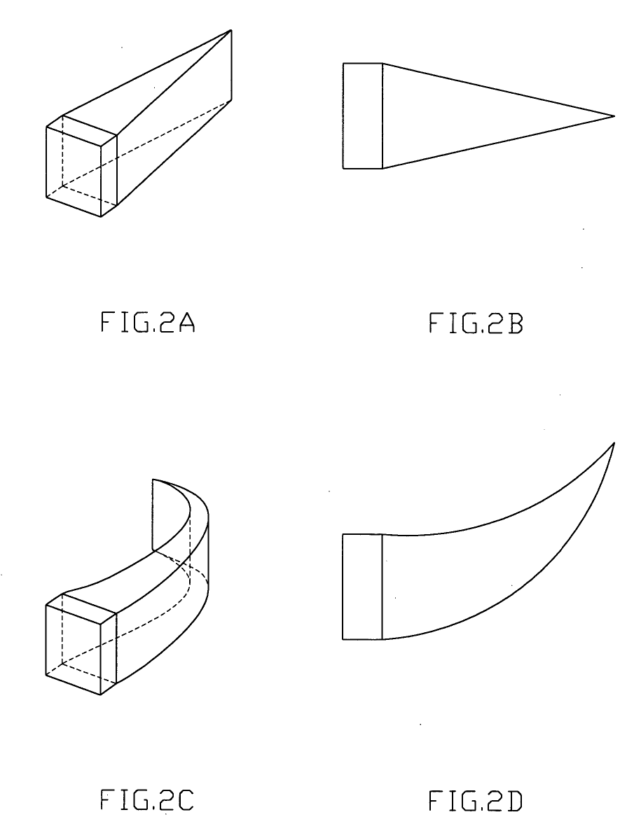

FIG. 2A and FIG. 2B are the perspective drawings and the top view of a straight-line-type wedge-shaped light-guiding apparatus of the present invention. The straight-line-type wedge-shaped light-guiding apparatus is configured between the light source module and the test sample, guiding an area light emitted from the light source module to be a linear light irradiating to the test sample. The geometric type of the light-guiding apparatus is not limited of above descriptions. FIG. 2C and FIG. 2D show the perspective drawing and the top view of an arc-line-type wedge-shaped light-guiding apparatus according to the present invention. The arc-line-type wedge-shaped light-guiding apparatus is capable of guiding area light to linear light in a direction different from the exciting direction of light. The exterior of the light-guiding apparatus of the present invention could be selected from a combination of a plurality of reflection elements such as stainless steel sheets. And the filler inside the light-guiding apparatus could be selected from the group consisting of glass, acrylics, polycarbonate (PC) and other materials to assist the light transmitted with a way of total reflection or partial reflection within the light-guiding apparatus. In addition, the light-guiding apparatus could be composed of a plurality of light guiding pipes such as bundle fibers. In the present invention, the light source module and the light-guiding apparatus could be integrated into a light source and guiding module for providing and transmitting a light to the test sample.

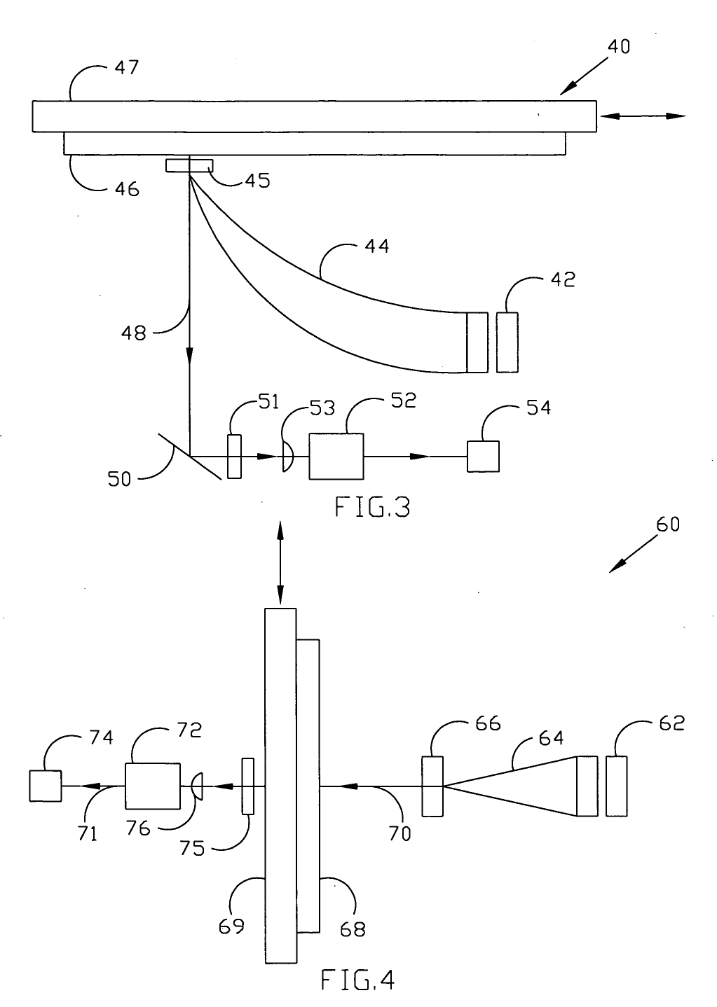

One preferred embodiment according to the present invention is shown in FIG. 3. An optical measurement apparatus 40, with the reflective formation of image, is provided with a light array 42, an arc-line-type wedge-shaped light-guiding apparatus 44, a platform 47, an emission mirror 50, a focusing lens 52, and a linear charge coupled device 54. The light array 42 and its control unit (not shown) are comprised in a light source module (not shown) of the optical measurement apparatus 40. The light array 42 could be composed of a plurality of LEDs or a plurality of OLEDs to provide a spontaneous emission light.

Because the cost of LED is far lower than the cost of a laser system, a large amount of LEDs could be used to compose the light array 42 of desired light intensity for scanning a test sample 46. The LEDs of the light array 42 could also be exchanged for providing the desired wavelength for illuminating the test sample 46. Different from a laser system of continuous excitation light, the light array 42 of LEDs could be switched swiftly for the linear charge coupled device 54 to detect an image signal. Further, the utilization of light array 42 of LEDs could simplify the operation for filtering noises of a laser system.

An excitation filter (not shown) could be arranged in the optical measurement apparatus 40 for filtering the spontaneous emission light, configured between the light array 42 and the arc-line-type wedge-shaped light-guiding apparatus 44. Besides, a light-mending lens (not shown) could also be arranged in the optical path of the light array 42 to enhance the quality of the spontaneous emission light, and the material of the light-mending lens could be selected from the group consisting of glass, acrylics, and polycarbonate.

The arc-line-type wedge-shaped light-guiding apparatus 44 is configured between the light array 42 and the test sample 46. Hence, an area of spontaneous emission light, emitted from the light array 42 of the light source module, is transformed into a linear light and be projected into the test sample 46 by the arc-line-type wedge-shaped light-guiding apparatus 44. The test sample 46 is arranged to place on a detection area (not shown) of a platform 47, and the platform 47 is used to support and transport the test sample 46 moving in one-dimension. In addition, the linear light will pass through the detection area when the test sample 46 is not available on the platform 47.

In this embodiment, the optical measurement apparatus 40 is also provided with a light-mending lens 45, configured between the arc-line-type wedge-shaped light-guiding apparatus 44 and the test sample 46 for trimming the light distribution of the spontaneous emission light, and the material of the light-mending lens 45 could be selected from the group consisting of glass, acrylics, and polycarbonate. Moreover, the optical measurement apparatus 40 could also comprise another excitation filter (not shown), configured between the arc-line-type wedge-shaped light-guiding apparatus 44 and the test sample 46 for filtering the spontaneous emission light and enhancing the quality of light. The excitation filter could also be configured between the arc-line-type wedge-shaped light-guiding apparatus 44 and the light array 42.

The test sample 46 could be selected from the array-type samples such as microarray sample, gene chip, protein chip, or ELISA-based biochip (enzyme-linked immunoabsorbent assay). And the optical characteristics produced from the test sample 46 could be transformed and detected by an imaging module and an image-sensing module of the optical measurement apparatus 40 as below description.

After the linear spontaneous emission light illuminates on the test sample 46, an emission light 48 is produced. Reflected and imaged by an emission error 50 and a linear charge couple device 54, the emission light 48 will finally be detected by a linear charge coupled device 54. In this embodiment, the emission mirror 50 and the focusing lens 52 are comprised in an image module (not shown). Besides, a micro diffraction grating 51 and a projection lens 53 are provided in the image module to trim the distribution of the emission light 48 and to project it into the linear charge coupled device 54.

An image-sensing module (not shown), comprising the linear charge coupled device 54 and its control unit (not shown), is arranged for detecting and processing the emission light 48. The image-sensing module could also comprise a filter lens and a dichroic mirror for achieving special functions. Furthermore, the image module and the image-sensing module could be integrated into a receiving module for receiving and processing the emission light 48 from the test sample 46. The linear charge coupled device 54 could also be replaced by an area charge coupled device or a complementary metal-oxide field effect transistor (MOSFET) sensor for detection the area light.

Because the arc-line-type wedge-shaped light-guiding apparatus 44 is arranged in the optical measurement apparatus 40 of this preferred embodiment, the space occupied by the optical measurement apparatus 40 could be minified. Besides, the arc-line-type wedge-shaped light-guiding apparatus 44 takes advantage of the full reflection of light to guide incident area excitation light to be linear excitation light of high luminous flux and extreme small area. Hence, when the test sample 46 is scanned, the platform 47, used to support the test sample 46, has only to move in one-dimensionally to proceed scanning. The one-dimensional motion of the platform 47 could be achieved by a reduction gear and driven from a stepping motor. This design of this preferred embodiment would not only save the space occupied by the optical measurement apparatus 40, but also simplify the complexity of the mechanism and save time for scanning the test sample 46. Further, the design of this optical measurement apparatus 40 will reduce overall processing cost for detecting an array-type sample.

Another preferred embodiment of the present invention is as shown in FIG. 4, an optical measurement apparatus 60, with piercing formation of image, is provided with a light array 62, an straight-line-type wedge-shaped light-guiding apparatus 64, a light mending module 66, a platform 69, a focusing lens 72, and a linear charge coupled device (CCD) 74. The light array 62 could be made up of a plurality of LEDs or a plurality of OLEDs. Because the cost of LED is far lower than the cost of a laser system, a large amount of LEDs could be used to compose the light array 62 of desired light intensity for scanning a test sample 68. The LEDs of the light array 62 could also be exchanged for providing a light with a desired wavelength. Different from a laser system of continuous excitation light, the light array 62 of LEDs could be switched swiftly for the linear charge coupled device 74 to have a correct detection. Utilizing the light array 62 of LEDs will reduces the operation for filtering noises of the conventional light source such as laser system.

In the operation of the optical measurement apparatus 60, first, an area spontaneous emission light 70 is emitted from the light array 62 and is then transformed as a linear light through the straight-line-type wedge-shaped light-guiding apparatus 64. Then the light-mending module 66, configured between the straight-line-type wedge-shaped light-guiding apparatus 64 and a test sample 68, is arranged to make the linear light with a uniform distribution.

After the linear spontaneous emission light 70 illuminates the test sample 68, an emission light 71 is produced, and the focusing lens 72 will transfer the emission light 71 to the linear charge coupled device 74. In addition, before the emission light 71 passes through the focusing lens 72, an excitation filter 75 and a micro diffraction grating 76 are arranged to filter out the excitation light and to trim the distribution of the emission light 71. According to the present invention, the linear charge coupled device 74 could be replaced by an area charge coupled device or a complementary metal-oxide field effect transistor (MOSFET) sensor for detection area light.

The above description of the preferred embodiments will not be used to limit the claims of the present invention; any change of equal effect or modifications that do not depart from the essence displayed by the invention should be limited in what is claimed in the following.

1. An optical measurement apparatus, comprising:
a light source and guiding module for providing a spontaneous emission light and transferring said spontaneous emission light to a linear incident light, and said linear incident light is passed through a detection area; and
a receiving module for imaging and processing said linear incident light passed through said detection area.

2. The optical measurement apparatus according to claim 1, wherein said light source and guiding module comprises a light source module and a light-guiding apparatus, and said light-guiding apparatus is configured between said light source module and said detection area.

3. The optical measurement apparatus according to claim 2, wherein said light source module is selected from the group consisting of a LED light array and an OLED light array.

4. The optical measurement apparatus according to claim 2, wherein the geometric type of the light-guiding apparatus is selected from the group consisting of an arc-line-type wedge-shaped light-guiding apparatus and a straight-line-type wedge-shaped light-guiding apparatus.

5. The optical measurement apparatus according to claim 2, wherein the filler inside said light-guiding apparatus is selected from the group consisting of glass, acrylics, and polycarbonate.

6. The optical measurement apparatus according to claim 2, wherein the exterior of the light-guiding apparatus is a combination of a plurality of reflection elements, said spontaneous emission light is reflected and transmitted by said reflection elements, and said plurality of reflection elements comprise a plurality of stainless steel sheets.

7. The optical measurement apparatus according to claim 2, wherein said light-guiding apparatus is the combination of a plurality of bundle fibers.

8. The optical measurement apparatus according to claim 2, wherein said optical measurement apparatus comprises an excitation filter, configured between said light source module and said detection area.

9. The optical measurement apparatus according to claim 2, wherein said optical measurement apparatus comprises a light-mending lens, configured between said light source module and said detection area, and the material of said light-mending lens is chosen from the group consisting of glass, acrylics, and polycarbonate.

10. The optical measurement apparatus according to claim 1, wherein said receiving module comprises an image module and an image-sensing module, and said image module is configured between said detection area and said image-sensing module.

11. The optical measurement apparatus according to claim 10, wherein said image module comprises a focusing lens.

12. The optical measurement apparatus according to claim 11, wherein said image module comprises a micro diffraction grating configured between said detection area and said focusing lens, and the image module comprises a projection lens between said focusing lens and said image-sensing module.

13. The optical measurement apparatus according to claim 10, wherein said image-sensing module comprises a filter lens and a dichroic mirror.

14. The optical measurement apparatus according to claim 10, wherein said image-sensing module comprises a sensor, and said sensor is selected from the group consisting of an area sensor and a linear sensor.

15. The optical measurement apparatus according to claim 1, further comprising a platform for supporting and transporting a test sample to move in one-dimension direction.

16. An optical measurement apparatus, comprising:
a light source module for providing a spontaneous emission light;
a light-guiding apparatus for transferring said spontaneous emission light to a linear incident light, and said linear incident light is passed through a detection area;
an image module for imaging said linear incident light passed through said detection area; and
an image-sensing module for receiving and processing said linear incident light imaged by said image module.

17. The optical measurement apparatus according to claim 16, further comprising a platform for supporting and transporting ad test sample to move in one-dimension direction, and said test sample is placed on said detection area.

18. The optical measurement apparatus according to claim 16, wherein said light source module is selected from the group consisting of a LED light array and an OLED light array.

19. The optical measurement apparatus according to claim 16, wherein said optical measurement apparatus comprises an excitation filter for filtering said spontaneous emission light.

20. The optical measurement apparatus according to claim 16, wherein said optical measurement apparatus comprises a light-mending lens, configured between said light source module and said detection area, and the material of said light mending-lens is chosen from the group consisting of glass, acrylics, and polycarbonate.

21. The optical measurement apparatus according to claim 16, wherein the geometric type of the light-guiding apparatus is selected from the group consisting of an arc-line-type wedge-shaped light-guiding apparatus and a straight-line-type wedge-shaped light-guiding apparatus.

22. The optical measurement apparatus according to claim 16, wherein the filler inside said light-guiding apparatus is selected from the group consisting of glass, acrylics, and polycarbonate.

23. The optical measurement apparatus according to claim 16, wherein the exterior of the light-guiding apparatus is a combination of a plurality of reflection elements, said spontaneous emission light is reflected and transmitted by said reflection elements, and said plurality of reflection elements comprise a plurality of stainless steel sheets.

24. The optical measurement apparatus according to claim 16, wherein said light-guiding apparatus is the combination of a plurality of light guiding pipe bundle fibers.

25. The optical measurement apparatus according to claim 16, wherein said image module comprises a focusing lens.

26. The optical measurement apparatus according to claim 16, wherein said image-sensing module comprises a filter lens and a dichroic mirror.

27. The optical measurement apparatus according to claim 16, wherein said image-sensing module comprises a sensor, and said sensor is selected from the group consisting of an area sensor module and a linear sensor module.
